(19) United States
(12) Patent Application Publication
(10) Pub. No.: US 2007/0208509 A1
(43) Pub. Date: Sep. 6, 2007

(54) Method of poling a glass ceramic body

(76) Inventors: Mark J. Davis, Clarks Summit, PA (US); Katherine Ann Gudgel, Evanston, IL (US); Peter Blaum, Budenheim (DE); Paula Vullo, Pittston, PA (US)

Correspondence Address: HARNESS, DICKEY & PIERCE, P.L.C., P.O. BOX 828, BLOOMFIELD HILLS, MI, 48303, US

(21) Appl. No.: 11/705,885

(22) Filed: Feb. 13, 2007

Related U.S. Application Data
(60) Provisional application No. 60/776,084, filed on Feb. 23, 2006.

(51) Int. Cl. G06F 19/00

(52) U.S. Cl. 702/1

(57) ABSTRACT

A method of selecting poling parameters for poling a glass ceramic body comprising ferroelectric domains, by applying an electric field across the glass ceramic body at a certain poling temperature for a certain poling time comprises the steps of: determining an upper bound of poling temperature given by the maximum poling temperature at which uncontrolled heat-up (thermal runaway) is avoided; and selecting the poling temperature to be smaller than the upper bound, preferably close to the upper bound.

### RELATED APPLICATIONS

This application claims the benefit of U.S. Provisional Application Ser. No. 60/776,084 filed on Feb. 23, 2006, the contents of which are fully incorporated herein by reference.

### BACKGROUND OF THE INVENTION

The invention relates to a method of selecting poling parameters for poling a glass ceramic body comprising ferroelectric domains, by applying an electric field across the glass ceramic body at a certain poling temperature and for a certain poling time.

The invention also relates to a method of poling a glass ceramic body comprising ferroelectric domains.

Poling relies on the unique feature of ferroelectric crystals of having tow or more stable orientation states on a microscopic level and the ability to switch from one state to another through the use of an applied field (e.g., electric field, stress, magnetic, or some combination of all three).

It is well known that ferroelectric ceramic materials like barium titanate, lead zirconate titanate (PZT) etc. exhibit piezoelectric properties when they have been previously subjected to a high direct current (DC) electric field at elevated temperatures. The application of high electric field enforces the rearrangement of spontaneous polarization of the domain structure and produces resultant polarization. Generally, in order to achieve proper electromechanical properties, a field higher than the coercive field (Ec) for the ceramics, is applied at elevated temperature approaching the Curie temperature during poling (V. N. Bindal et al.: “An improved method of poling for piezoelectric ceramic materials”, Ferroelectrics, 1982, vol. 41, pp. 179-180).

According to P. Bryant, “Optimization of poling conditions for piezoelectric ceramics” in Ceramic Developments edited by C. C. Sorrell and B. Ben-Nissan, Materials Science Forum, Volumes 34-36 (1988 pp. 285-289) the poling process is governed by several poling parameters, which include temperature, temperature profile, voltage level, voltage profile, A.C. voltages in conjunction with DC voltage, poling jig design and handling procedure. Poling is generally carried out at an elevated temperature in an oil bath. The maximum usable temperature is determined by the Curie temperature of the ceramic and the type of oil being used. According to P. Bryant, the degree of poling measured in terms of the piezoelectric coefficient d₃₃ depends mainly on electric field strength, poling temperature, sintering temperature of the PZT material and poling time. It was reported that a higher electric field strength of 3 MV/m leads to lower piezoelectric coefficients. The highest piezoelectric coefficients were found at an electric field strength of 1.5 MV/m at a poling temperature of 180° C. and a sintering temperature of 1210° C. Further P. Bryant reported that poling is a logarithmic process (at least in the early stages) but that there is a leveling off with very long poling times.

V. N. Bindal et al. mentioned above disclose the application of vibrations during poling to improve the poling process.

According to Qing Xu et al., “Influences of poling condition and sintering temperature on piezoelectric properties of (Na_{0.5}Bi_{0.5})₁₋ₓBaₓTiO₃ ceramics”, Material Research Bulletin 40 (2005) pp. 373-382 the piezoelectric coefficient d₃₃ decreases with higher poling temperatures in sodium bismuth titanate. A poling field strength of 3.0 MV/m was reported to be optimal.

According to U.S. Pat. No. 2,702,427 in PZT the application of an electric field greater than about 2 MV/m, preferably in the range of 2-4 MV/m, leaves the element strongly polarized upon removal of the field. Because the breakdown potential for the material may not be appreciably above about 4 MV/m, this field strength is regarded as a practical upper limit for the polarizing field.

However, with respect to the poling of piezoelectric glass ceramic materials, it is virtually unknown how these materials can effectively be poled.

### SUMMARY OF THE INVENTION

In view of this, it is a first object of the invention to disclose a method of selecting poling parameters for poling a glass ceramic body comprising ferroelectric domains.

It is a second object of the invention to disclose a method of poling a glass ceramic body comprising ferroelectric domains.

According to the invention these and further objects are solved by a method of selecting poling parameters for poling a glass ceramic body comprising ferroelectric domains, by applying an electric field across the glass ceramic body at a certain poling temperature for a certain poling time, the method comprising the steps of:

(a) determining an upper bound for poling temperature (Tₘₐₓ), the upper bound (Tₘₐₓ) being given by the maximum poling temperature at which uncontrolled heat-up (thermal runaway) is avoided; and

(b) selecting the poling temperature to be smaller than the upper bound.

According to the invention it was found that in glass ceramics the maximum poling temperature is limited by a thermal runaway effect. This is due to the inverse dependence of the resistivity of the piezoelectric glass ceramic on temperature and is considered a general phenomenon associated with such materials. If temperature becomes too high, the resistivity of the material will be lowered to a point at which significant conduction current takes place and, due to inevitable loss within the material, will lead to sample heating. This heating may then lead to an ever-increasing conductivity and can lead to thermal runaway (breakdown).

According to the invention, the upper bound of poling temperature (Tₘₐₓ) is determined first and the poling temperature is then selected to be smaller than the upper bound.

According to a preferred development of the invention, the poling temperature is selected close to the upper bound, preferably larger than Tₘₐₓ=100 K, more preferably larger than Tₘₐₓ−50 K, more preferably larger than Tₘₐₓ−20 K, mostly preferable larger than Tₘₐₓ−10 K.

Using such a poling temperature which is only slightly lower than the upper bound which avoids thermal runaway a very effective poling process can be performed.

According to another development of the invention, a lower bound (Tₘᵢₙ) is determined for the poling temperature which is given by the Curie temperature (T_{C}) of the ferroelectric phase(s) in the glass ceramic body minus 100 K (Tₘᵢₙ=T_{C}−100 K), in the poling temperature selected between the upper and lower bounds.

If the poling temperature is too low, this will lead to sluggish realignment of the ferroelectric domains. Thus, preferably, the poling temperature is higher than T_{C}−100 K and, preferably, is close to the upper bound of poling temperature.

According to another development of the invention, the upper bound of poling temperature is determined by increasing temperature for a given electric field during poling while monitoring current through the glass ceramic body, and the maximum poling temperature at which a steady state current is achieved during poling is selected as upper bound of poling temperature.

Such an empirical determination of the maximum poling temperature is the simplest way to determine the upper bound.

According to another embodiment of the invention, the upper bound of poling temperature is approximated by calculating, based on specific size and shape of the glass ceramic body, on furnace geometry, and on temperature dependence of DC resistivity, a maximum power dissipation that the glass ceramic body can handle to yield a thermal steady state during poling.

Such a calculation will preferably be done prior to determining the upper bound of poling temperature empirically as indicated above.

According to another development of the invention, an upper bound of electrical field strength is determined for the electric field applied across any ferroelectric glass ceramic body, the upper bound being determined by the avoidance of arcing and dielectric breakdown of the glass ceramic body and by the available voltage source.

Preferably, the upper bound of the electric field strength is 10 MV/m, preferably 8 MV/m, mostly preferred 5 MV/m. Lower fields are generally preferred to minimize the chance of electrical arcing.

It was found that an electric field strength larger than usually used in the poling or conventional piezoelectric ceramics (up 4 MV/m), such as PZT, can be used without using silicone or similar electrically-insulating oils when using glass ceramic bodies of a larger size, thereby providing a larger gap between the electrodes. Thus glass ceramic bodies having a diameter of at least 25 mm, preferably of at least 35 mm may be used in combination with electrodes having a diameter of about 20 mm. Larger samples sizes can also be poled using this scheme. In general, the distance between the edge of the electrodes and the edge of the sample should be preferably greater than 5 mm. The glass ceramic bodies may have a thickness that is preferably between 0.1 mm and 5 mm, most preferably between 0.5 and 2 millimeters.

Consequently, it is possible to use a higher electric field strength without using silicone oil which would limit the poling temperature to about 200° C.

According to another embodiment of the invention, a lower bound of electrical field strength is determined for the electric field applied across any ferroelectric glass ceramic body, the lower bound being determined by the field strength allowing sufficient domain realignment for a given poling temperature within a reasonable time which is perferably lower than 300 minutes.

The lower bound for any ferroelectric glass-ceramic is preferably 0.5 MV/m, more preferably 1 MV/m, further preferred 2 MV/m, mostly preferred 3 MV/m. In general, however, the most preferable lower bound is based on the deviation from quadratic relationship between d33 and Electric Field as seen in FIG. 1.

According to another development of the invention, an upper bound for the poling time for applying a certain electric field at a certain poling temperature across any ferroelectric glass ceramic body is set to 300 minutes, preferably to 100 minutes, mostly preferred to 60 minutes.

Using such a poling time allows to carry out the poling process in a reasonable time economical for a series production.

According to another embodiment of the invention, a lower bound is determined for the poling time for applying a certain electric field at a certain poling temperature across any ferroelectric glass ceramic body, the lower bound being given by the time needed to effect domain realignment during poling at a given poling temperature and a given electric field strength such that desired performance specifications are met.

The lower bound of poling time is preferably set to 1 minute, more preferably to 3 minutes, mostly preferred to 10 minutes.

The poling time is preferably set within a range of 12 to 18 minutes, more preferably to about 15 minutes.

The object of the invention is further solved by a method of poling a glass ceramic body comprising ferroelectric domains, the method comprising the steps of:

(c) providing a glass ceramic body comprising ferroelectric domains;

(d) selecting poling temperature, electric field strength as outlined before, in particular by selecting a poling temperature which is smaller than the upper bound of poling temperature avoiding thermal runaway;

(e) eating the glass ceramic body to the poling temperature;

(f) applying an electric field of the selected electric field strength across the glass ceramic body for the selected poling time; and

(g) cooling the glass ceramic body to room temperature.

Preferably the electric field is switched off during or after cooling to room temperature, preferably when reaching a temperature lower than 150° C., more preferably when reaching a temperature lower than 100° C.

Using such a procedure a more effective poling can be performed.

According to another development of the invention, silver electrodes, preferably consisting of air-dried silver paint, are applied to opposite sides of the glass ceramic body prior to poling.

This is a simple means of connecting the DC voltage source to the glass ceramic body for applying the electric field during poling.

The glass ceramic body may preferably comprise SiO₂, Na₂O, K₂O and Nb₂O₃. Nonetheless, the poling procedure outlined herein is applicable to any ferroelectric glass-ceramic.

More preferably, the glass ceramic body comprises (in weight percent):

| | |
|---|---|
| SiO₂ | 15-40 |
| Na₂O | 1-20 |
| K₂O | 1-20 |
| Nb₂O₃ | 10-70. |

More preferably, the glass ceramic body used for poling comprises (in weight percent):

| | |
|---|---|
| SiO₂ | 20-25 |
| Na₂O | 5-10 |
| K₂O | 5-15 |
| Nb₂O₃ | 50-70. |

Such a glass ceramic material can readily be made from a respective precursor glass by a ceramization procedure and leads to a stable glass ceramic which can effectively be poled according to the invention.

It will be understood that the features of the invention may not only be used as described above, but also in other combinations or independently.

### BRIEF DESCRIPTION OF THE DRAWINGS

The invention will now be more fully described with reference to the drawings in which:

FIG. 1 is a plot of the piezoelectric constant d₃₃ over the electric field strength;

FIG. 2 is a plot of the piezoelectric constant d₃₃ over poling temperature;

FIG. 3 is a plot of the piezoelectric constant d₃₃ over poling time; and

FIG. 4 is a plot of a scheme showing the selection of poling temperature and electric field strength.

### DETAILED DESCRIPTION OF THE PREFERRED EMBODIMENTS

In Table 1 the components of a base glass from which glass ceramic samples were prepared is given. The precursor glass was molten from suitable starting components to yield a homogeneous precursor glass of the composition given in Table 1.

The precursor glass samples were then ceramized using ceramization conditions as given in Table 2. In Table 2 also electrical and piezoelectric properties and XRD results for the ceramized samples are given.

In Table 2, the following abbreviations are used:

| | |
|---|---|
| Tnuc (° C.): | nucleation temperature in ° C. |
| t_{nuc} (hrs): | nucleation time in hours |
| T_{gr} (° C.): | crystallization temperature in ° C. |
| t_{gr} (hrs): | crystallization time in hours |
| q-heat (K/hr): | heating rate in Kelvin per hour |
| q-cool (K/hr): | cooling rate in Kelvin per hour |
| d₃₃ (pC/N): | piezoelectric coefficient that describes the change in |
| | electrical polarization along the 3-direction due to |
| | an induced stress along the 3-direction given in |
| | Picocoulomb per Newton |
| K₃₃: | electrical permittivity measured along the 3-direction |

The piezoelectric charge constant d₃₃ was measured using an APC wide-range d₃₃ meter, model YE 2730 A. This instrument is based on the Berlincourt method of measuring piezoelectric properties. A reference sample of PZT was used. Permitivity measurements (K₃₃) and loss measurements (tan δ) were made using HP precision LCR meter, model 4284 A, a key slay Multimeter Keithley (temperature monitoring), and a Banstead/Thermolyne Furnace, model 47900. All x-ray diffraction measurements (XRD) were made with a Philips PW 1800 θ/θ diffractometer with nominal settings of Cu-radiation at 40 kV/30 mA over the angular range of 10° to 70° with a step size of 0.02° and an exposure time of 10 seconds/step. Rietveld analysis was used to reduce the data in terms of weight fraction and nominal crystal size. In this application crystal sizes defined as the smallest dimension of the crystal structure based on the broadening of x-ray diffraction peaks.

All sample sizes were 35 mm diameter, 2 mm thick.

The XRD reveals that after ceramization the samples were fully crystallized without any remaining amorphous phase (see Table 2).

With the sample according to Table 1 and Table 2 a systematic poling stud was performed.

The most important independent variables in the poling process were determined to be: poling temperature, electric field strength, and poling time. The results indicated that a proper balance between all three variables is necessary to reach optimum poling results.

According to the invention, a systematic means by which determine optimum poling parameters for ferroelectric glass ceramics is given.

By contrast with respect to standard poling conditions used when poling PZT, according to the invention much higher poling temperatures are considered which usually exceed 200° C. Therefore, preferably, no silicon oil was used which would limit temperatures to about 200° C. A solution was found using non-traditional samples. Normally, thin disk- or plate-like samples are electroded to their very edge. Without the use of an insulating fluid, electrical arching across a 1 mm gap would seriously limit the upper voltage that can be used. However, according to the invention relatively large samples were made which had a diameter of 35 mm and which were 2 mm thick (in some cases 0.5 mm thick).

These samples were used in combination with electrodes of 20 mm diameter. The resulting gap of about 7.5 mm between the edge of the electrode and the edge of the sample allowed to use much higher voltages (>5 kV) than normally used in conventional poling.

Air-dried silver paint was used for the electrodes, typically allowing >2 hours drying time before any measurements would take place, though more commonly over night.

As noted above, the poling process is governed by three main factors: Time, temperature and electric field. Of these, the latter two play a more important role, but all three were examined in detail (see below). Temperature is constrained by two considerations: If the temperature is too low, the kinetics of domain reorientation may be too sluggish for effective poling. Alternatively, if the temperature is too high, the resistivity of the material will be lowered to the point at which significant conduction current takes place, and, due to inevitable loss within the material, will lead to sample heating. This heating then may lead to an ever-increasing conductivity and can lead to thermal runaway (breakdown). This process was, in fact, observed and appeared as an uncontrolled increase in sample current at nominally isothermal oven conditions.

To quantify thermal runaway during poling, one may look at an energy balance for a nominally isothermal sample (assumed herein), ignoring radiative and convective heat loss.

$$ρ {VC}_{p} \frac{ⅆ T}{ⅆ t} = {q}_{cond}^{″} A + {E}_{g} \qquad ( Eq . 1 )$$

where ρ is density, V is sample volume, Cₚ is sample heat capacity, T is temperature, t is time, q_{cond}″ is the conductive heat transfer per unit area (A), and E_{g} is the volumetric heat generation that arises from Joule heating (=I²R, where I is the electrical current and R is the sample's DC resistance). The conductive term can be approximated as:

$${q}_{cond}^{″} = - 2 k \frac{T - {T}_{∝}}{L} \qquad ( Eq . 2 )$$

where k is heat conductivity, T here is the sample's instantaneous temperature, T_{∝} is the far-field temperature (oven temperature), and L is the sample thickness. The factor of 2 arises from two thermally conducting surfaces (top and bottom). Heat loss through the thin sides is ignored. For conditions under which internal heat generation exceeds heat loss via conduction, the net result is that the sample will heat up. Using representative values for the samples of L=1 mm, A=6.3×10⁻⁴ m², k=1.5 W/m/K, an (observed) runaway current ˜30 μA, R˜10⁷ Ω (thus yielding about 9 mW of power dissipated in the sample due to Joule heating), there is a calculated overheat (T−T_{∝}) of only 0.5 mK at steady-state conditions (i.e., dT/dt=0).

Alternatively, ignoring conductive losses, an instantaneous pulse of 10 mW of power dissipated in the sample with an assumed density of 3000 kg/m³, a heat capacity of 1000 J/(kg·K), and an effective volume of 3.14×10⁻⁷ m³, leads to a calculated heating rate dT/dt of only 10 mK/sec initially. Once this heating has begun, conductive losses will, of course, serve to decrease the heating rate unless the rate of Joule heating outpaces heat loss via thermal conduction.

Due to an exponential relationship between electrical conductivity and temperature on the one hand and a linear dependence of conductive losses on temperature (equation 2), it can be seen that thermal runaway conditions can easily occur and how important it is to find an optimum poling temperature which is slightly below the maximum possible temperature at which thermal runaway will occur.

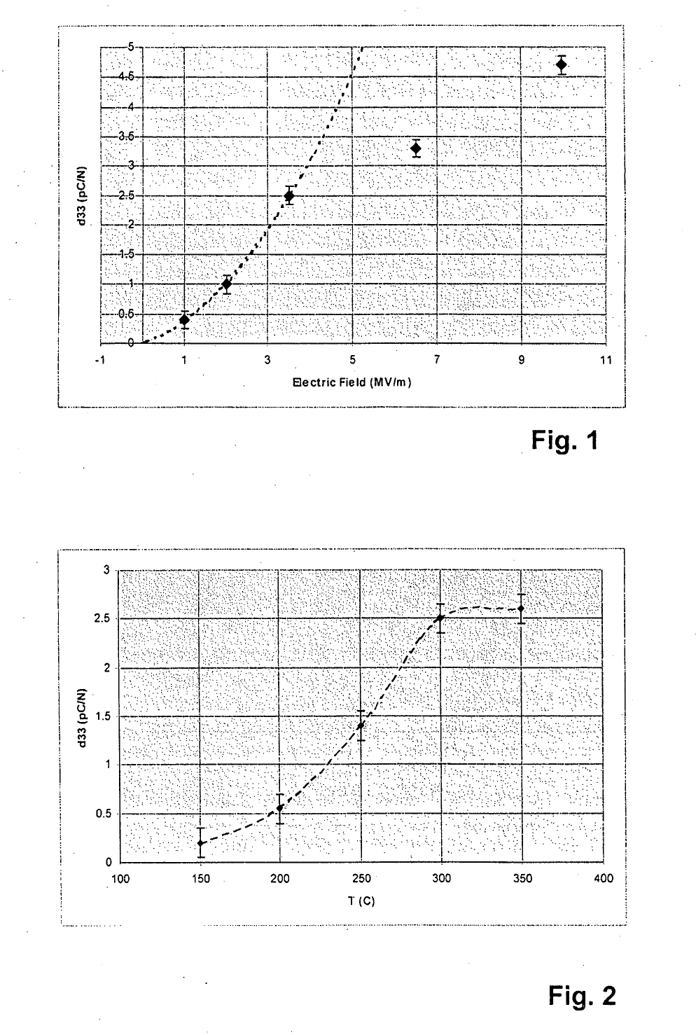

In a first set of experiments, all poling took place at 300° C. with a poling time of 3 minutes, after which the oven was turned off, the door was opened, but the electric field was left on until the oven temperature reached about 90° C., at which point the field was turned off and the sample removed from the oven. Before the d₃₃ measurement, the sample was short-circuited for 10 seconds, and then measured using the Berlincourt device. The observed non-linear dependence of the resulting d₃₃ on electric field exhibits two main regions (FIG. 1). For lower field strengths (<5 MV/m), there is a pronounced quadratic dependence of d₃₃ on field strength, whereas at higher field strengths, saturation is observed. It is believed that the low-field, quadratic dependence is due to the fact that the amount of power dissipated in the samples scales with the square of the electric field. The energy associated with this is consumed in domain realignment during poling.

The next set of experiments focused on the temperature dependence of the poling process. For these experiments, a three-minute poling time was again used and the same cooling procedure was followed as per the above discussion. Here, a pronounced increase and measured d₃₃ is again seen, up to about 300° C., above which no further increase in d₃₃ is observed (FIG. 2).

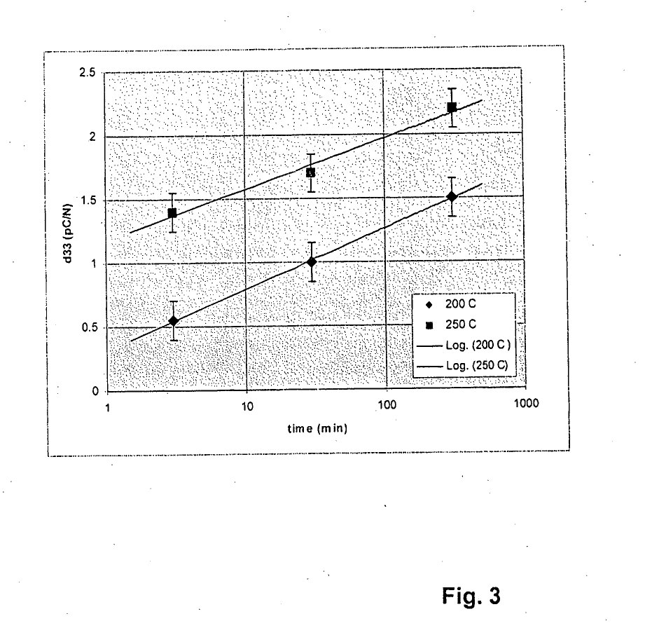

A further set of experiments focused on time-dependence of the poling process. For these experiments, two temperatures were used (200 and 250° C.), and the same cooling procedure was used again. Poling times were 3, 30, and 300 minutes in duration. When d₃₃ is plotted against log (time), a clear linear dependence is observed, indicating a logarithmic dependence of resulting d₃₃ on poling time (see FIG. 3).

Table 4 summarizes the upper, lower and optimum levels of poling time, temperature, and electric field strength for the successful poling of ferroelectric glass ceramics.

Most important is the consideration of conditions under which thermal runaway takes place which must be avoided during poling, however, poling temperature may be as close as possible to the temperature before thermal runaway occurs. This will yield optimum poling conditions due to faster domain realignment at higher temperature.

The upper bound of poling temperature Tₘₐₓ may be estimated by calculation taking into account the dependence of resistivity on temperature which is clearly exponential (see Table 3), and further using equations 1 and 2 for approximation as explained above.

However, normally an exact calculation of Tₘₐₓ at which thermal runaway occurs, will be difficult, largely to the generally unknown heat transfer characteristics of a given poling system (i.e., sample geometry, electrode configuration, oven environment, etc.). However, Tₘₐₓ may readily be determined by increasing the poling temperature and simply monitoring the change of sample current with time. If, at a constant field, the current through the sample increases, usually slowly at first, but with an ever-increasing rate at later times, thermal runaway is occurring. One can then decrease the temperature (or field) to the point at which runaway does not occur, thereby estimating the maximum power dissipation the sample can handle, and thereby estimating Tₘₐₓ for a given electric field strength.

The lower bound of poling temperature is governed by effecting significant domain realignment with a given electric field strength. Usually the lower bound of temperature Tₘᵢₙ is set to be within 100 K off the Curie temperature: Tₘᵢₙ=T_{C}−100 K. As further summarized in Table 4, the upper bound of the electric field strength is limited by either arching across contacts (˜7 kV) if not using silicon oil, or by dielectric breakdown of the sample itself (usually >10 MV/m).

The lower bound of the electric field strength is determined by a sufficient field strength so that significant domain realignment takes place. The sample thickness should be sufficiently thick for mechanical strength while maintaining mostly defect-free quality.

Given commercially available high-voltage sources, 0.5 to 2.0 mm thick samples provide ideal balance between sample robustness and field strength.

Given the logarithmic dependence on poling time (see FIG. 3) the upper bound of poling time is governed by realistic processing durations. Thus poling time should usually be no longer than 1 hour, except in extraordinary circumstances.

The lower bound of poling time is determined by a sufficiently long poling time to lead to small errors on poling duration control (>1 min). For most cases the optimum poling time will be between 10 and 30 minutes.

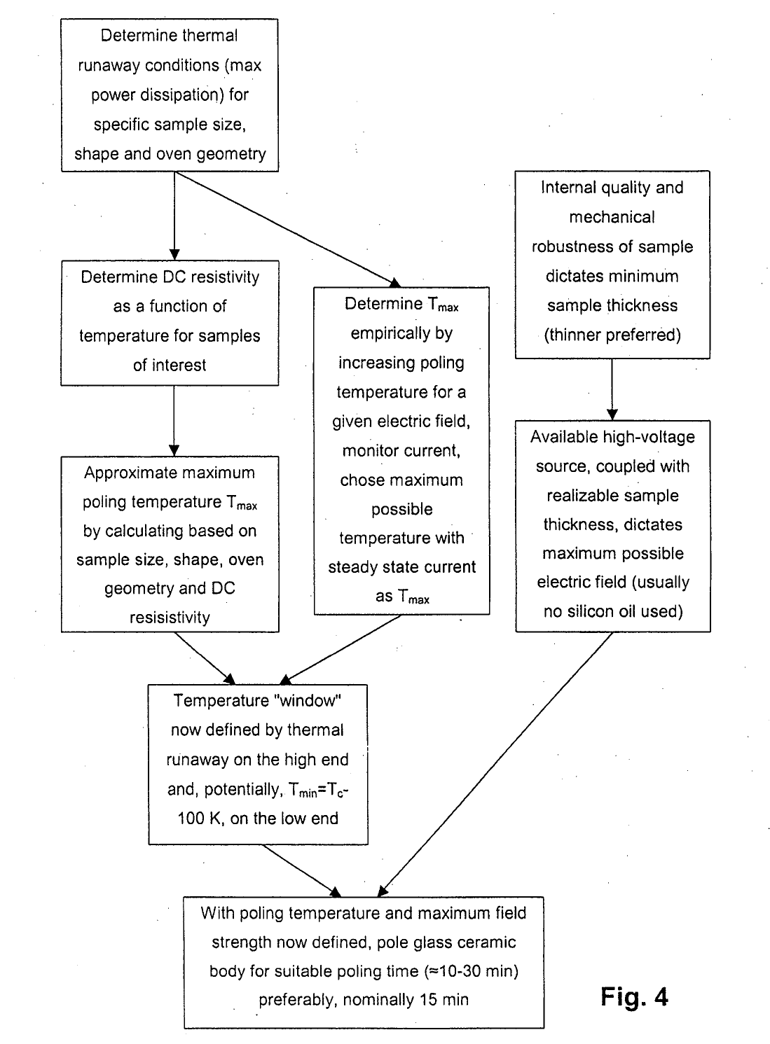

The method of selecting optimum poling parameters according to the invention is summarized in FIG. 4.

TABLE 1

| Component | mol % | wt % |
|---|---|---|
| SiO₂ | 45.5 | 22.6 |
| Na₂O | 13.6 | 7.0 |
| K₂O | 13.6 | 10.6 |
| Nb₂O₅ | 27.3 | 59.8 |
| Total | 100.0 | 100.0 |

TABLE 2

| Tnuc (° C.) | none |
|---|---|
| tnuc (hrs) | none |
| Tgr (° C.) | 1000 |
| tgr (hrs) | 4 |
| q-heat (K/hr) | 300 to 550; 100 to 1000 |
| q-cool (K/hr) | 300 |
| K₃₃ | 80.0 |
| tan δ | 0.039 |
| Comments | Opaque white glass-ceramic |
| XRD (wt %) | |
| Amorphous | 0.0 |
| NaNbO₃ | 46.2 |
| cryst size (nm) | 29.0 |
| K₃(NbO₂)₃(Si₂O₇) | 21.6 |
| cryst size (nm) | 22.0 |
| KNbSi₂O₇ | 32.2 |
| cryst size (nm) | 22.0 |

TABLE 3

| T (° C.) | R (DC; Ohms) | I (μA) | Power (mW) |
|---|---|---|---|
| 23 | 3.00E+11 | 0.01 | 0.01 |
| 100 | 1.10E+11 | 0.02 | 0.03 |
| 150 | 1.60E+10 | 0.1 | 0.2 |
| 200 | 4.90E+09 | 0.4 | 0.6 |
| 250 | 5.80E+09 | 0.3 | 0.5 |
| 300 | 4.30E+08 | 4.1 | 7.1 |
| 350 | 5.63E+07 | 31.1 | 54.4 |
| 400 | 1.18E+07 | 148.3 | 259.5 |

TABLE 4

| | Time | Temperature | Field |
|---|---|---|---|
| Upper Bound | Logarithmic dependence on poling | Limited by temperature at which | Limited by either arcing across |
| | time, combined with realistic | thermal runaway occurs for a | contacts (˜7 kV) if not using |
| | processing durations, effectively | given electrical field strength | silicone oil, or by dielectric |
| | limits poling times to <1 hr, except | | breakdown of sample itself |
| | in extraordinary circumstances | | (usually >10 kV/mm) |
| Optimum | 10-30 min for most cases | Must be within window dictated by | Given commercially-available |
| | | upper and lower temperature bounds, | high-voltage sources, 0.5 to 2.0 |
| | | provided electrical field strength | mm-thick samples provide ideal |
| | | is sufficiently strong to enable | balance between sample robustness |
| | | domain movement on 10-30 min timescale | and field strength |
| Lower Bound | Sufficiently long to lead to small errors | Should be ˜100° C. of Curie | Electric field must be sufficiently |
| | on poling duration control >1 min) | temperature to enable significant | strong so that significant domain |
| | | domain realignment | realignment takes places; sample |
| | | | thickness should be sufficiently thick |
| | | | for mechanical strength while |
| | | | maintaining mostly defect-free quality |

1. A method of selecting poling parameters for poling a glass ceramic body comprising ferroelectric domains by applying an electric field across the glass ceramic body at a certain poling temperature for a certain poling time, the method comprising the steps of:
(a) determining an upper bound of poling temperature (Tₘₐₓ), the upper bound (Tₘₐₓ) being given by the maximum poling temperature at which uncontrolled heat-up (thermal runaway) is avoided on a sample glass ceramic body; and
(b) selecting the poling temperature to be smaller than the upper bound.

2. The method of claim 1, further comprising the steps of:
determining a lower bound of poling temperature (Tₘᵢₙ), the lower bound being given by the Curie temperature (T_{C}) of the glass ceramic body minus 100 K (Tₘᵢₙ=T_{C}−100 K); and
selecting the poling temperature between the upper and lower bounds.

3. The method of claim 1, wherein the poling temperature is selected close to the upper bound, but larger than Tₘₐₓ minus 100 K.

4. The method of claim 2, wherein the poling temperature is selected larger than Tₘₐₓ minus 20 K.

5. The method of claim 1, further comprising the steps of:
determining the upper bound of poling temperature by increasing temperature for a given electric field during poling of a sample glass ceramic body while monitoring current through the sample glass ceramic body;
determining a maximum temperature at which a steady state current is achieved through the sample body during poling thereof; and
selecting the maximum temperature as an upper bound of poling temperature.

6. The method of claim 1, wherein the upper bound of poling temperature is approximated by calculating, based on specific size and shape of the glass ceramic body, on furnace geometry, and on temperature dependence of DC resistivity, a maximum power dissipation the glass ceramic body can handle to yield a thermal steady state during poling.

7. A method of selecting poling parameters for poling a glass ceramic body comprising ferroelectric domains by applying an electric field across the glass ceramic body at a certain poling temperature for a certain poling time, the method comprising the steps of:
selecting an electric field strength between 1 MV/m and 10 MV/m;
determining an upper bound of poling temperature (Tₘₐₓ) by increasing temperature for said selected electric field strength during poling of a sample glass ceramic body while monitoring current through the sample glass ceramic body;
determining a maximum temperature at which a steady state current is achieved through the sample body during poling thereof;
selecting the maximum temperature as an upper bound of poling temperature;
selecting a lower bound of poling temperature (Tₘᵢₙ), the lower bound being given by the Curie temperature (T_{C}) of the glass ceramic body minus 100 K (Tₘᵢₙ=T_{C}−100 K); and
selecting said poling temperature between said upper and lower bounds, close to said upper bound.

8. The method of claim 7, wherein the upper bound of electrical field strength is determined for the electric field applied across the glass ceramic body, the upper bound being determined by the avoidance of arcing and dielectric breakdown of a sample glass ceramic body.

9. The method of claim 1, wherein 10 MV/m is selected as an upper bound of the electric field strength.

10. The method of claim 1, wherein a lower bound of electrical field strength is determined for the electric field applied across a sample glass ceramic body, the lower bound being determined by a field strength allowing sufficient domain realignment on the sample glass ceramic body for a given poling temperature within an upper bound of poling time.

11. The method of claim 10, wherein 1 MV/m is selected as the lower bound of the electric field strength.

12. The method of claim 7, wherein an upper bound of poling time for applying a certain electric field at a certain poling temperature across the glass ceramic body is set to 300 minutes.

13. The method of claim 7, wherein a lower bound of poling time is determined for applying a certain electric field at a certain poling temperature across the glass ceramic body, the lower bound being given by the time needed to effect sufficient domain realignment during poling at a given poling temperature and a given electric field strength.

14. The method of claim 13, wherein the lower bound of poling time is set to 1 minute.

15. The method of claim 1, wherein the poling time is set within a range of 3 to 18 minutes.

16. A method of poling a glass ceramic body comprising ferroelectric domains, the method comprising the steps of:
(c) providing a glass ceramic sample body comprising ferroelectric domains;
(d) applying an electric field across the glass ceramic body at a certain poling temperature for a certain poling time;
(e) determining an upper bound of poling temperature (Tₘₐₓ), the upper bound (Tₘₐₓ) being given by the maximum poling temperature at which uncontrolled heat-up (thermal runaway) is avoided on the sample body;
(f) determining a lower bound of poling temperature (Tmin), the lower bound being given by the Curie temperature (T_{C}) of the glass ceramic body minus 100 K (Tₘᵢₙ=T_{C}−100 K);
(g) selecting the poling temperature between the upper and lower bounds.
(h) providing a glass ceramic body to be poled;
(i) heating the glass ceramic body to the poling temperature;
(j) applying an electric field across the glass ceramic body for poling the glass ceramic body; and
(k) cooling the glass ceramic body to room temperature.

17. The method of claim 16, wherein the electric field is switched off before cooling to room temperature.

18. The method of claim 17, wherein the electric field is switched off when reaching a temperature lower than 150° C.

19. The method of claim 18, wherein a glass ceramic body is provided comprising (in wt.-%):

| | |
|---|---|
| SiO₂ | 15-40 |
| Na₂O | 1-20 |
| K₂O | 1-20 |
| Nb₂O₃ | 10-70. |

20. The method of claim 19, wherein a glass ceramic body is provided comprising (in wt.-%):

| | |
|---|---|
| SiO₂ | 20-25 |
| Na₂O | 5-10 |
| K₂O | 5-15 |
| Nb₂O₃ | 50-70. |
